(19) United States
(12) Patent Application Publication
(10) Pub. No.: US 2025/0315874 A1
(43) Pub. Date: Oct. 9, 2025

(54) SYSTEM AND METHOD OF MATCHING BUYERS AND SUPPLIERS

(71) Applicant: Matium, Inc., Baltimore, MD (US)

(72) Inventors: Bailey Robin, Pasadena, MD (US); Alexander Lambrides, Arlington, VA (US)

(73) Assignee: Matium, Inc., Baltimore, MD (US)

(21) Appl. No.: 18/627,674

(22) Filed: Apr. 5, 2024

(51) Int. Cl. G06Q 30/0601; G06F 40/20

(52) U.S. Cl. CPC G06Q 30/0631; G06F 40/20

(57) ABSTRACT

A system comprising a matching server that executes the processing described herein. The processing includes receiving, from a prospective buyer, requirements for a desired product. The matching server also receives product descriptions from each of a plurality of suppliers. The server may then compare the requirements with some or all of the product descriptions. The corresponding products are then ranked according to how well the product descriptions meet the requirements, to create an overall ranking, that may then be output to the buyer.

### BACKGROUND OF THE INVENTION

### Field of the Invention

The disclosure below relates to facilitation of buying and selling of products and services.

### Background Art

When a buyer seeks a product or service, or when a supplier seeks a buyer, the process may be complex, time-intensive, and error-prone. This is particularly true in business-to-business transactions, where significant costs and commitments may be at stake. A buyer may have to sort through and identify potential suppliers, articulate particular requirements for the goods or services (e.g., quantity and quality of material, price, delivery parameters, etc.) and select a supplier with the hopes that the selected supplier can deliver the desired goods or services according to stated technical requirements, and can do so in a timely and cost-effective manner. A buyer may further wish that a supplier obtain or produce and/or deliver the goods in an environmentally conscious, sustainable way.

Current practices for such transactions can also entail significant risk for both parties. The supplier may have concerns as well as the buyer. Was the supplier's understanding of the buyer's requirements accurate? Is the buyer a reliable party as to payment obligations? Each party relies on the other to fulfill their respective commitments, and the operations of each can be severely impacted if the other does not meet the expectations of the other.

### BRIEF DESCRIPTION OF THE DRAWINGS/FIGURES

FIG. 1 illustrates a network architecture of an embodiment.

FIG. 2 illustrates an example of buyer requirements.

FIG. 3 illustrates data inputs and outputs at a matching server, according to an embodiment.

FIG. 4 illustrates the use of criterion-based rankings, according to an embodiment.

FIG. 5 illustrates data flow and processing according to an embodiment.

FIG. 6 is a flow chart illustrating processing at a matching server, according to an embodiment.

FIG. 7 illustrates information provided to a buyer, according to an embodiment.

FIG. 8 illustrates a computing system of a matching server, according to an embodiment.

Further embodiments, features, and advantages of the present invention, as well as the operation of the various embodiments of the present invention, are described below with reference to the accompanying drawings.

### DETAILED DESCRIPTION OF THE INVENTION

Embodiments of the present invention are now described with reference to the figures. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

The system described herein comprises a matching server that executes the processing described herein. The processing includes receiving, from a prospective buyer, requirements for a desired product. The matching server also receives product descriptions from each of a plurality of suppliers. The server may then compare the requirements with some or all of the product descriptions. The corresponding products are then ranked according to how well the product descriptions meet the requirements, to create an overall ranking, that may then be output to the buyer.

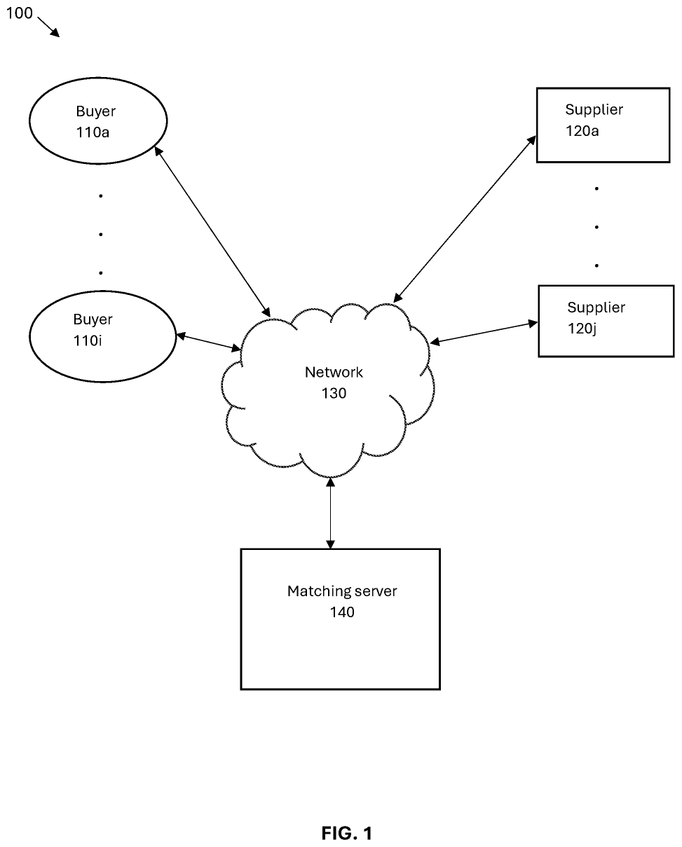

FIG. 1 illustrates a network architecture 100 in which an embodiment of the invention may operate. A number of buyers 110a through 110i may be connected to one or more matching servers 140. In an embodiment, this connection may take place via a network infrastructure 130. This network infrastructure may include one or more local area networks, wide area networks, and/or the Internet. One or more prospective suppliers 120a through 120j may also be connected to the matching server 140 through the network(s) 130. As will be discussed in greater detail below, the buyers may provide descriptions of the products that they need to the matching server 140. The suppliers 120 may provide descriptions of the products that they offer to the matching server 140 as well. This allows the matching server 140 to identify and rank suppliers that may be able to meet the requirements identified by a given buyer. Note that in the present document, the term “product” is used broadly to include both tangible, physical products as well as services.

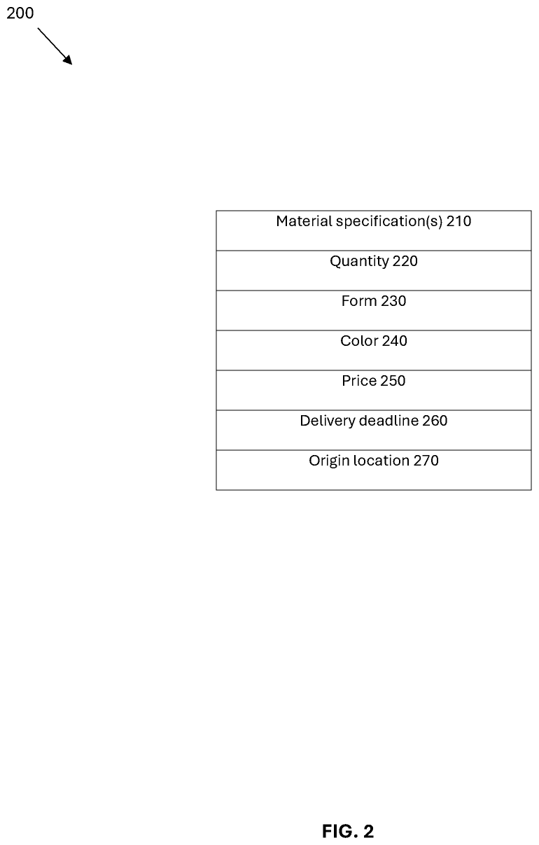

FIG. 2 shows a list of requirements that a prospective buyer might specify for purchase of a product or material. The material specifications 210 refer to physical properties of a product. This might refer to a grade of a material (if, for example, the material is unformed metal, plastic, or wood), or other material qualities, such as hardness/malleability, tensile strength, density, permeability, etc., depending on the nature of the material. Other requirements that a buyer might specify include the quantity 220, a form factor 230, a color 240, a price 250, and delivery-related information, such as a delivery deadline 260 and location of origin 270. In other instances, a buyer may have more, fewer, or different requirements. The kinds of requirements specified may depend on factors such as the intended use of the product, the industry, the nature of the material. Note also that a requirement may be precisely defined, e.g. a price of $100 per unit quantity, or may be specified as a range, e.g., a price between $90-$100. Other numerical requirements may likewise be specified as a precise value or as a range.

In an embodiment, the requirements may be provided by the buyer in the form of answers to questions in a questionnaire. The questionnaire may be presented by the matching server and completed on-line. In an alternative embodiment, the buyer may describe his/her requirements in a natural language format. In this case, the matching server may include a trained large language model (LLM) with which to convert the natural language description, using artificial intelligence methods, into a set of discrete parametrized data items.

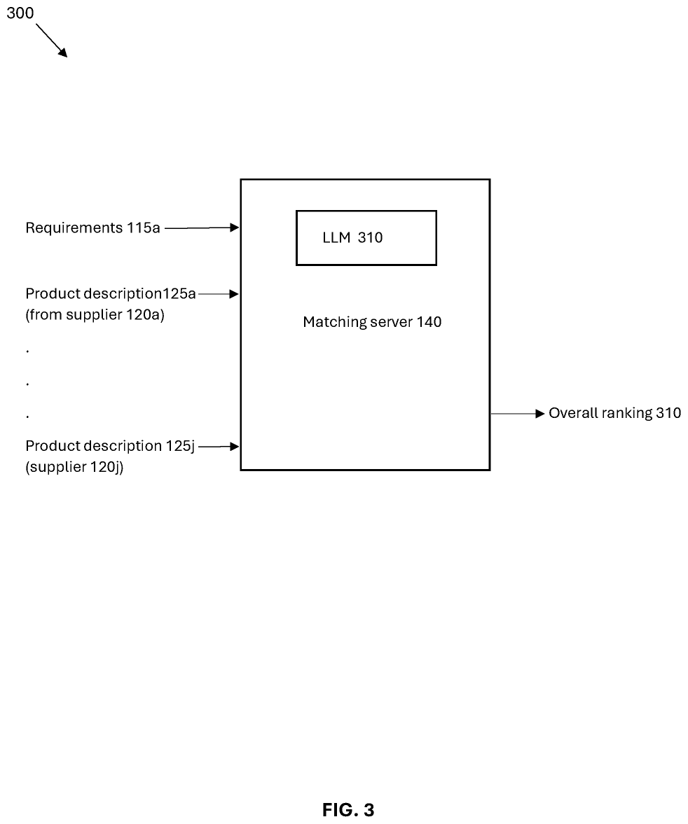

FIG. 3 is a data flow diagram illustrating the information inputs and outputs at the matching server 140. The server 140 may receive requirements 115a from a buyer. If necessary, requirements 115a may be converted from a natural language format into a discrete set of parametrized data items (such as that shown in FIG. 2) using a large language model 310 implemented at the matching server 140. Suppliers 120a . . . 120j (see FIG. 1) may also input data, which is shown here as respective product descriptions 125a . . . 125j. The matching server 140 may then compare the requirements 115a to each of the product descriptions 125a . . . 125j. The comparisons may be used to rank the described products according to how well each product matches requirements 115a.

Product descriptions may be obtained in different ways in various embodiments. They may be solicited after matching server 140 receives requirements 115a. Alternatively, product descriptions may be received in advance and stored in local memory or in a database accessible by matching server 140. In the case of product descriptions received in advance, suppliers may upload its product descriptions for one or more offered products and update them over time as necessary.

Note that while the matching server is shown here and in other figures as a single computing device 140, in various implementations the matching server may be implemented as more than one server. In such embodiments, the servers may be collocated or may be remotely interconnected and synchronized through network 130.

The comparison and ranking processes may be performed in various ways in different embodiments, as would be understood by a person of ordinary skill in the art. For example, the number of requirements that are matched by a particular product could be counted, and products could be ranked by the number of matched requirements. Alternatively, any difference between a particular requirement and a corresponding feature of a product could be quantified, where an exact match in a requirement could be assigned a value of zero, signifying no difference. The sum of the differences could be used to rank the products inversely, such that products with lower sums are ranked more highly, as better matches for a set of requirements. Alternatively, such per-requirement differences could be determined and the products could be ranked inversely according to Pythagorean distance. Alternatively, certain differences could be weighted in a manner specified by the buyer.

In an embodiment, the products could be ranked according to each of several criteria, where some of the criteria may correspond to respective requirements. For example, the products could be ranked by price, to create a price-based ranking. The products could be ranked by the sustainability of the product and supplier (Does the product comprise sustainable material(s)? Is the delivery method environmentally friendly?). The products could also be ranked by how closely they materially match the requirements of the buyer, and/or how convenient the delivery/distribution process might be for the buyer.

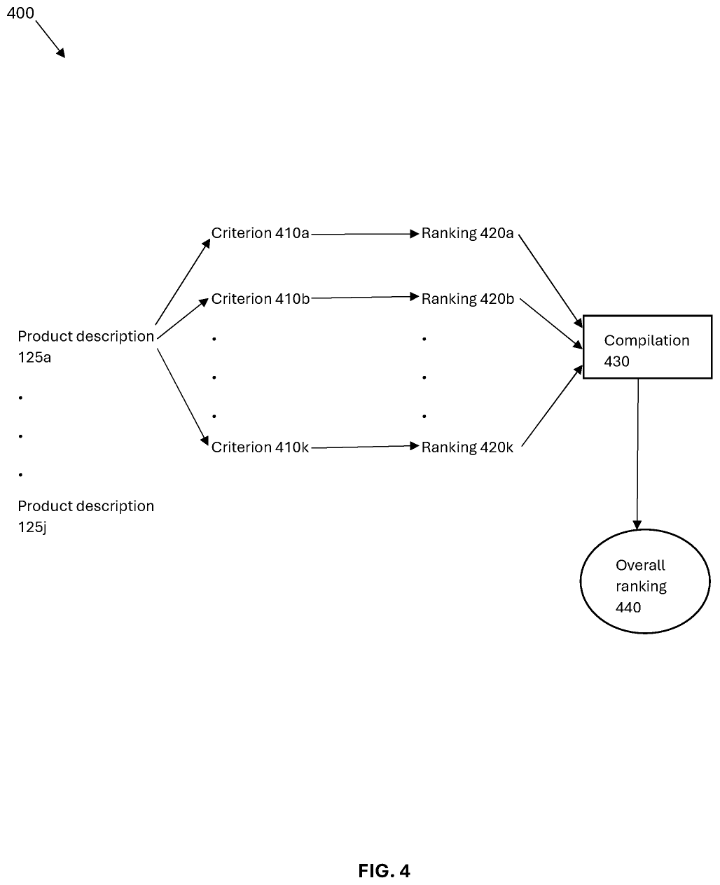

This approach is illustrated in FIG. 4. Here, a product description 125a is evaluated against each of several criteria, shown as criteria 410a . . . 410k. As discussed above, the criteria may be based at least in part on the requirements 115a of a buyer 110a. Similarly, a product description 125b is evaluated against each of the several criteria 410a . . . 410k, product description 125c is evaluated against each of the k criteria, etc. The result is a set of criteria-based rankings, 420a . . . 420k. Each of these rankings is an ordered (ranked) list of the products that correspond to the respective product descriptions 125. For example, one ranking might be a list of the products according to how closely they can meet the buyer's desired price point; another could be a list of the products according according to how sustainable the product and/or the supplier might be.

In the illustrated embodiment, the criteria-based rankings 420 may then be compiled at 430 to generate an overall ranking 440. In an embodiment, the buyer may be presented with the overall ranking as well as the individual criteria-based rankings. The compilation 430 may take place in any of several ways in different embodiments. A given product will have different positions in each of the criteria-based rankings 420a . . . 420k; its placement in the overall ranking 440 may be a function of the individual rankings, such as an arithmetic average for example. In an alternative embodiment, the individual rankings may be weighted before the averaging. For example, the price-based ranking may be given a higher weight than the other rankings if price is the chief concern. Such a weighting may be predetermined or may be driven by preferences of the buyer.

In an embodiment, a buyer's preferences as to which criteria or which requirements are the most significant may be captured and used to inform future rankings. In such an embodiment, a buyer's ultimate choice of a product may be recorded along with the context of his/her choice, i.e., the overall ranking presented to the buyer, along with any individual criteria-based rankings. Based on the choice made, its context, and on previous choices made by the same buyer and the contexts of those prior choices, analysis may be performed to determine that buyer's tendencies or preferences.

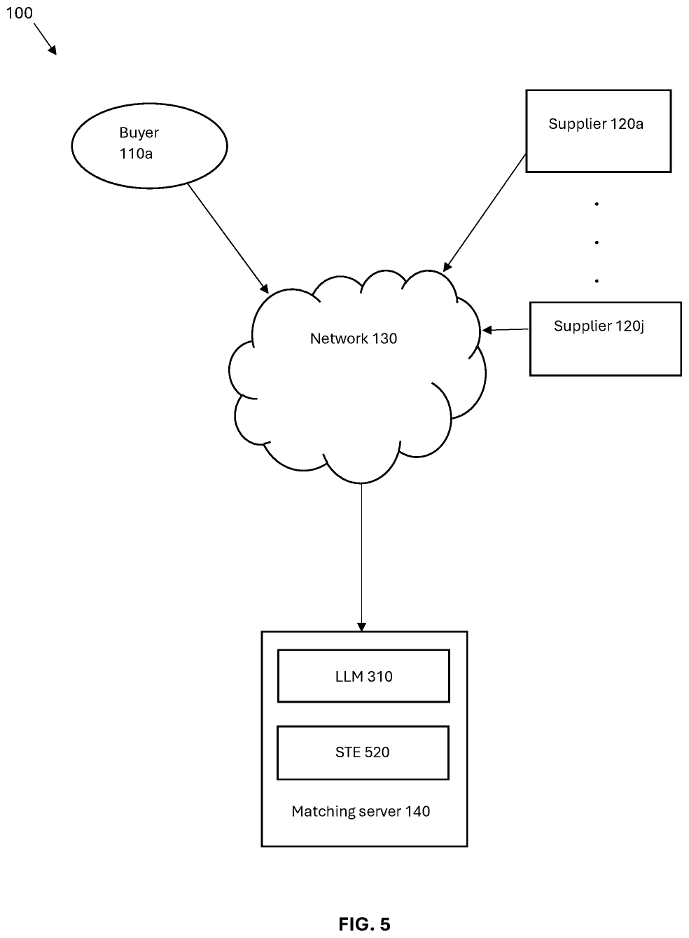

This is illustrated in the embodiment of FIG. 5. Here, a buyer 110a provides requirements 115a to the matching server 140 via network infrastructure 130. If the requirements 115a are in a natural language format, the matching server 140 may include logic and data for a large language model (LLM) 310, to convert the natural language requirements into a set of discrete parametrized data items. Suppliers 120a . . . 120j may provide product descriptions 125a . . . 125j to the matching server 140. A process such as that discussed above with respect to FIG. 4 may be used to determine criteria-based rankings of the product descriptions 125a . . . 125j and to determine an overall ranking.

A selection tendency engine (STE) 520 may be implemented in the matching server 140. The STE 520 may take into account previous choices made by buyer 110a along with the contexts of those choices to determine tendencies of the buyer 110a. In an embodiment, the STE 520 may include logic that trains artificial intelligence infrastructure, such as one or more neural networks, to create a trained model that can identify preferences of the buyer 110a. Learning such tendencies may then be used to affect a future overall ranking of products for that buyer. In this manner, products which the buyer 110a is likely to prefer may be intelligently advanced to higher spots in a future ranked list.

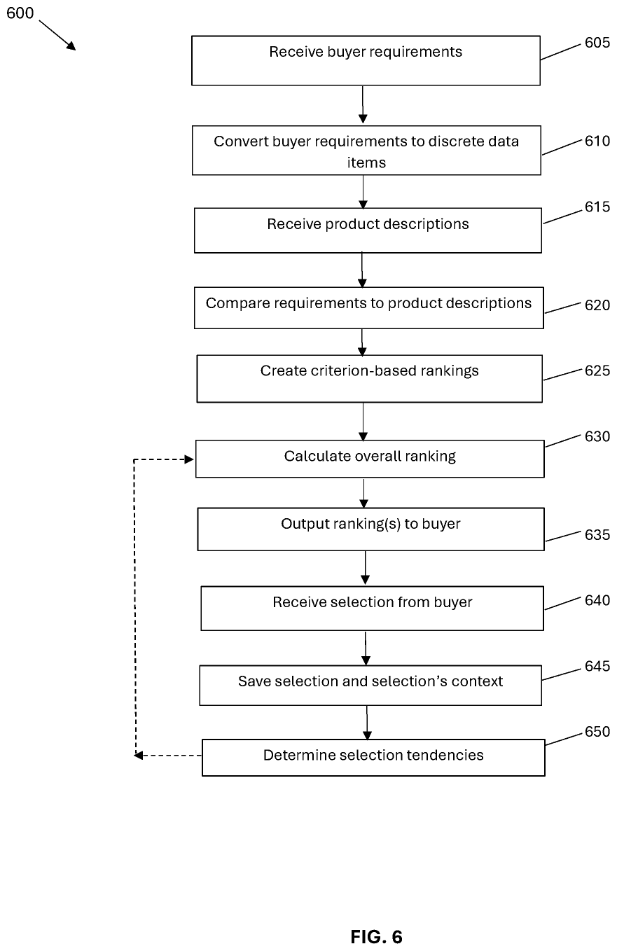

Processing 600 at the matching server 140 is illustrated in FIG. 6, according to an embodiment. At 605, a buyer's requirements for a product may be received. At 610, the buyer's requirements, if in a natural language form, may be converted into discrete parametrized data items using an LLM for example. At 615, product descriptions may be received from prospective suppliers. In an embodiment, such descriptions may be solicited from suppliers; in another embodiment, product descriptions may have been previously uploaded to the matching server and stored in memory.

At 620, the requirements are compared to each of the product descriptions. If criterion-based rankings are to be created, this may be done at 625. At 630, an overall ranking of the products is created. The overall ranking, and any criterion-based rankings, may be sent to the buyer at 635 for display. The buyer may then make a choice of a product; this selection may be received by the matching server at 640. In an embodiment, the selection may be confirmed to the buyer by the matching server and the selected supplier may be informed of the buyer's choice.

At 645, this selection and its context (i.e., the overall ranking of products and any criterion-based rankings) may be saved at the matching server. This selection and its context, along with this buyer's past selections and respective contexts, may be used to derive selection tendencies of the buyer at 650. Such tendencies, which reflect the buyer's preferences, may then be fed back to the logic which calculates the overall ranking (650), to be used to inform future overall rankings. In this way, subsequent rankings may become smarter and better attuned to the buyer's preferences. Future overall rankings can therefore intelligently reflect what the buyer tends to prefer, and products that he/she is more likely to want can be more highly ranked.

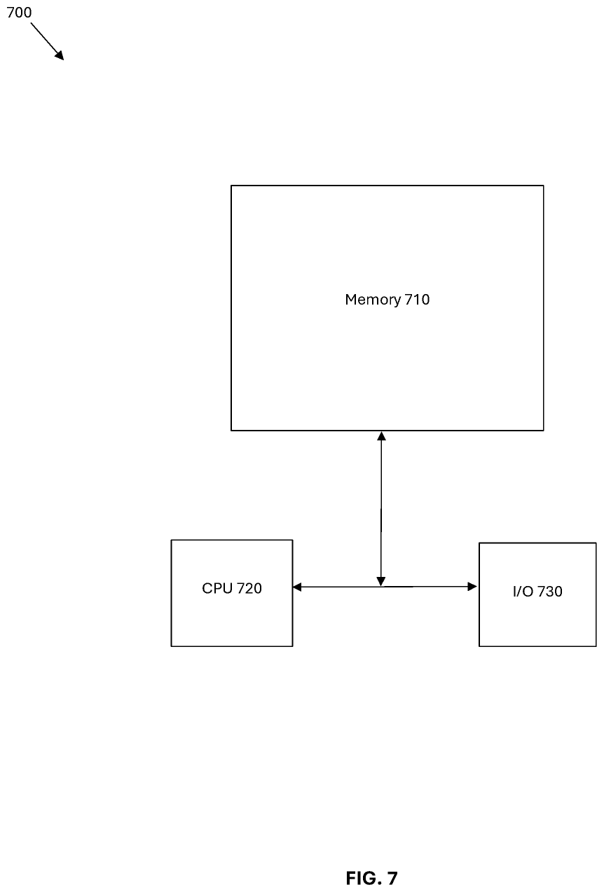

The logic of FIG. 6 may be embodied as software, firmware, hardware, or any combination thereof. FIG. 7 illustrates a computing platform 700 of matching server 140. The computing platform can be any commercially available and well-known computer capable of performing the functions described herein.

The computing platform 700 may include one or more central processing units (CPUs) 720. The CPU 720 may be connected to a communication bus that enables communication with a main or primary memory 710. The primary memory 710 has stored therein control logic (computer software) comprising the logic shown in FIG. 6, and related data.

The computer 700 also includes input/output (I/O) device(s) 730, such as monitors, keyboards, pointing devices, and network connectivity infrastructure that allows communication with network 130.

Any apparatus or manufacture comprising a computer useable or readable medium having control logic (software) stored therein is referred to herein as a computer program product or program storage device. This includes, but is not limited to, the computer 700 and its memory 710. Such computer program products have control logic stored therein that, when executed by CPU 720, cause computer 700 (and matching server 140) to operate as described herein.

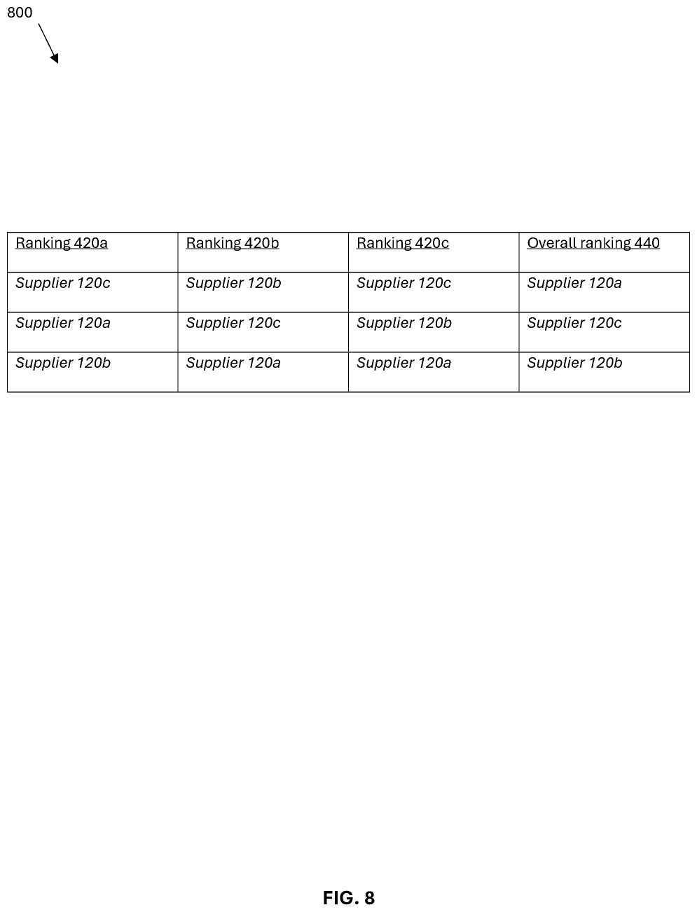

FIG. 8 illustrates the data 800 that may be output to the buyer as a result of process 600. As discussed above, one or more criteria-based rankings may be generated. These may be displayed to the buyer as criteria-based rankings 420a, 420b, and 420c. In the embodiment shown here, rankings are presented in terms of the suppliers of the respective products. In alternative embodiments, the rankings may be presented in terms of the product names.

Ranking 420a is based on a criterion 410a (see FIG. 4), leading to the product of supplier 120c being ranked first, followed by the product of supplier 120a, followed by the product of supplier 120b. Ranking 420b is based on criterion 410b, leading to the product of supplier 120b being ranked first, followed by the product of supplier 120c, followed by the product of supplier 120a. Ranking 420c is based on criterion 410c, leading to the product of supplier 120c being ranked first, followed by the product of supplier 120b, followed by the product of supplier 120a.

The criteria-based rankings may be compiled into an overall ranking 440. In the example of FIG. 8, this lists the product of supplier 120a, followed by the product of supplier 120c, followed by that of supplier 120b. In an embodiment, the buyer may select a particular supplier by clicking on the corresponding supplier button under any of the rankings, which would take the buyer to the appropriate page of the supplier's website.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments describe the general nature of the invention so that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

What is claimed is:

1. A method, performed at a server, comprising:
receiving, from a buyer, requirements for a desired product;
receiving, from each of a plurality of suppliers, product descriptions;
comparing the requirements with the product descriptions;
ranking the products corresponding to the product descriptions according to how well the product descriptions meet the requirements, to create an overall ranking; and
outputting the overall ranking to the buyer.

2. The method of claim 1, further comprising:
converting the received requirements to a discrete parametrized form of the requirements, performed prior to said comparison.

3. The method of claim 2, wherein said converting is performed using an artificial intelligence large language model.

4. The method of claim 1, wherein the ranking comprises ranking the products with respect to each of one or more criteria, to create corresponding one or more criteria-based rankings.

5. The method of claim 4, wherein the overall ranking is created as a function of at least the criteria-based rankings.

6. The method of claim 4, further comprising:
outputting the one or more criteria-based rankings.

7. The method of claim 4, further comprising:
receiving, from the buyer, a selection of one of the products and its accompanying supplier.

8. The method of claim 7, further comprising:
saving the selection;
saving the one or more criteria-based rankings as a selection context;
adding the selection and its selection context to any previously saved selections and selection contexts for the buyer;
determining one or more selection tendencies for the buyer based on the saved selections and selection contexts of the buyer; and
using the one or more selection tendencies as a factor in determining future overall rankings for the buyer.

9. The method of claim 8, wherein the determination of the one or more selection tendencies for the buyer is performed using a trained artificial intelligence model.

10. A system, comprising:
a processor; and
a memory, the memory having stored therein instructions executable by said processor, the instructions configured to cause the processor to:
receive, from a buyer, requirements for a desired product;
receive, from each of a plurality of suppliers, product descriptions;
compare the requirements with the product descriptions;
rank the products corresponding to the product descriptions according to how well the product descriptions meet the requirements, to create an overall ranking; and
output the overall ranking to the buyer.

11. The system of claim 10, wherein the instructions are further configured to cause the processor to:
convert the received requirements to a discrete parametrized form of the requirements, performed prior to said comparison.

12. The system of claim 11, wherein said converting is performed using an artificial intelligence large language model.

13. The system of claim 10, wherein the ranking comprises ranking the products with respect to each of one or more criteria, to create corresponding one or more criteria-based rankings.

14. The system of claim 13, wherein the overall ranking is created as a function of at least the criteria-based rankings.

15. The system of claim 13, wherein the instructions are further configured to cause the processor to:
output the one or more criteria-based rankings.

16. The system of claim 13, wherein the instructions are further configured to cause the processor to:
receive, from the buyer, a selection of one of the products and its accompanying supplier.

17. The system of claim 16, wherein the instructions are further configured to cause the processor to:
save the selection;
save the one or more criteria-based rankings as a selection context;
add the selection and its selection context to any previously saved selections and selection contexts for the buyer;
determine one or more selection tendencies for the buyer based on the saved selections and selection contexts of the buyer; and
use the one or more selection tendencies as a factor in determining future overall rankings for the buyer.

18. The system of claim 17, wherein the determination of the one or more selection tendencies for the buyer is performed using a trained artificial intelligence model.

19. A computer program product comprising a computer useable medium having control logic stored therein, the computer control logic comprising computer readable program code means for causing the computer to:
receive, from a buyer, requirements for a desired product;
receive, from each of a plurality of suppliers, product descriptions;
compare the requirements with the product descriptions;
rank the products corresponding to the product descriptions according to how well the product descriptions meet the requirements, to create an overall ranking; and
output the overall ranking to the buyer.
